(19) United States
(12) Patent Application Publication
(10) Pub. No.: US 2020/0219164 A1
(43) Pub. Date: Jul. 9, 2020

(54) SYSTEMS AND METHODS FOR PURCHASE RECOMMENDATION

(71) Applicant: Mastercard International Incorporated, Purchase, NY (US)

(72) Inventor: Manoneet KOHLI, White Plains, NY (US)

(73) Assignee: Mastercard International Incorporated, Purchase, NY (US)

(21) Appl. No.: 16/239,692

(22) Filed: Jan. 4, 2019

(51) Int. Cl. G06Q 30/06; G06K 9/00; G06F 3/0482

(52) U.S. Cl. CPC G06Q 30/0631; G06Q 30/0639; G06F 3/0482; G06K 9/00671; G06Q 30/0623

(57) ABSTRACT

A system for image-based purchase recommendation is disclosed. The system can include a memory storing computer program code and at least one processor, wherein the computer program code is configured to cause the system to receive a digital image corresponding to an item of interest, analyze the digital image, and identify one or more corresponding recommended products. The system can determine one or more merchants that offer one or more recommended products. The system can organize the identified merchants based on an availability of additional services offered by the merchants or based on services offered by one or more issuers, form a list of recommended merchants and transmit the recommended products, list of merchants, and the address (physical and/or internet) of each merchant, to a user device.

### BACKGROUND

The disclosed subject matter relates to systems and methods for generating purchase recommendations.

In the course of their daily lives, people encounter many different goods and services that they may want to learn more about and that they may want to purchase in the future. It may also be the case that a person encounters a product about which the person desires more information regarding similar alternative products and merchants that sell that product. Absent further information regarding, for example, price, alternative products, and purchasing options at the time of the encounter with a product, people may simply not be able to collect such information. As a result, not only might those individuals lack information regarding future purchases, but they may not be able to locate the previously-encountered products to make a purchase—informed or otherwise.

Accordingly, there exists a need for improved systems and methods for purchase recommendation, including systems and methods that enable individuals to identify products of interest and provide various other information to assist in locating and purchasing those, and other related products.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a computer-implemented method for image-based purchase recommendation is disclosed. The method can include receiving, by processing circuitry, a digital image corresponding to an item of interest. The computer-implemented method can further include analyzing the digital image, by the processing circuitry, to identify one or more corresponding recommended products. The method can include determining, by the processing circuitry, one or more merchants that offer one or more recommended products. The method can include identifying, by the processing circuitry, a location of each merchant that has a physical location, and an internet address of each merchant that offers the one or more products for sale on the internet. The method can further include forming a list of merchants by organizing the one or more merchants based on an availability of additional services offered. The additional services may be offered by the one or more merchants or by one or more issuers. The method can then include transmitting, by the processing circuitry, the identified one or more products, the list of merchants, and the identified merchant location or internet address for each merchant, to a user device.

For purpose of illustration and not limitation, the digital image can include one of a captured image of a product, a bitmap, a QR code, a barcode, a brand name, a product name, or a product logo.

For purpose of illustration and not limitation, the additional services can include one or more offers associated with a merchant or rewards associated with a payment product.

For purpose of illustration and not limitation, the list of merchants transmitted to a user device can include the additional services offered by the one or more merchants or one or more issuers.

For purpose of illustration and not limitation, the method can include organizing the list of merchants based on one or more user inputs indicating whether the list of merchants should include one or both of physical merchant locations and internet addresses for each merchant.

For purpose of illustration and not limitation, the identified one or more products, the list of merchants, and the identified merchant location or internet address for each merchant can be configured to be displayed in coordination with an application associated with one or more payment products.

For purpose of illustration and not limitation, the application can be configured to display the identified one or more products, the list of merchants, and the identified merchant location or internet address for each merchant.

For purpose of illustration and not limitation, organizing the one or more merchants can include organizing the one or more merchants based on whether the one or more merchants accept a particular payment product or payment via a particular payment method.

For purpose of illustration and not limitation, the digital image can be transmitted to the processing circuitry via the application.

For purpose of illustration and not limitation, the method can include transmitting, by the processing circuitry, the identified one or more products, the list of merchants, and the identified merchant location or internet address for each merchant, configured as a one of a searchable list or a map of merchant locations.

In accordance with another aspect of the disclosed subject matter, a system for image-based purchase recommendation is disclosed. The system can include at least one memory storing computer program code and at least one processor, wherein the computer program code is configured, when executed by the at least one processor, to cause the system to receive a digital image corresponding to an item of interest. The system can be configured to analyze the digital image and thereby identify one or more corresponding recommended products. The system can be configured to determine one or more merchants that offer one or more recommended products. The system can be configured to identify a location of each merchant that has a physical location, and an internet address of each merchant that offers the one or more products for sale on the internet. The system can be configured to organize the one or more merchants based on an availability of additional services offered by the one or more merchants or by the one or more issuers, to form a list of recommended merchants. The system can further be configured to transmit, to a user device, the identified one or more products, the list of merchants, and the identified merchant location or internet address for each merchant.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIG. 2 is a diagram illustrating a system for purchase recommendation according to an illustrative embodiment of the disclosed subject matter.

FIG. 3 is a diagram illustrating representative screenshots generated at a user device according to an illustrative embodiment of the disclosed subject matter.

FIG. 4 is a flow chart illustrating a representative method for purchase recommendation, implemented according to an illustrative embodiment of the disclosed subject matter.

FIG. 5 is a flow chart illustrating a representative method for purchase recommendation, implemented according to an illustrative embodiment of the disclosed subject matter, from the perspective of a user device.

FIG. 6 is a block diagram illustrating further details of a representative computer system according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods and systems presented herein can be used for producing purchase recommendations.

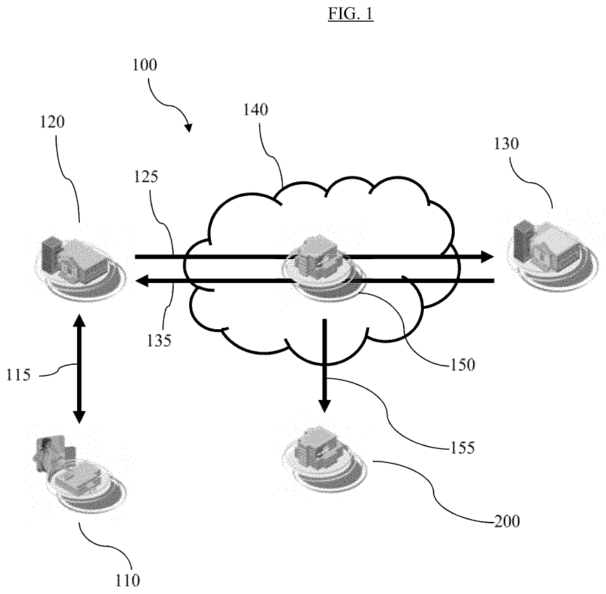

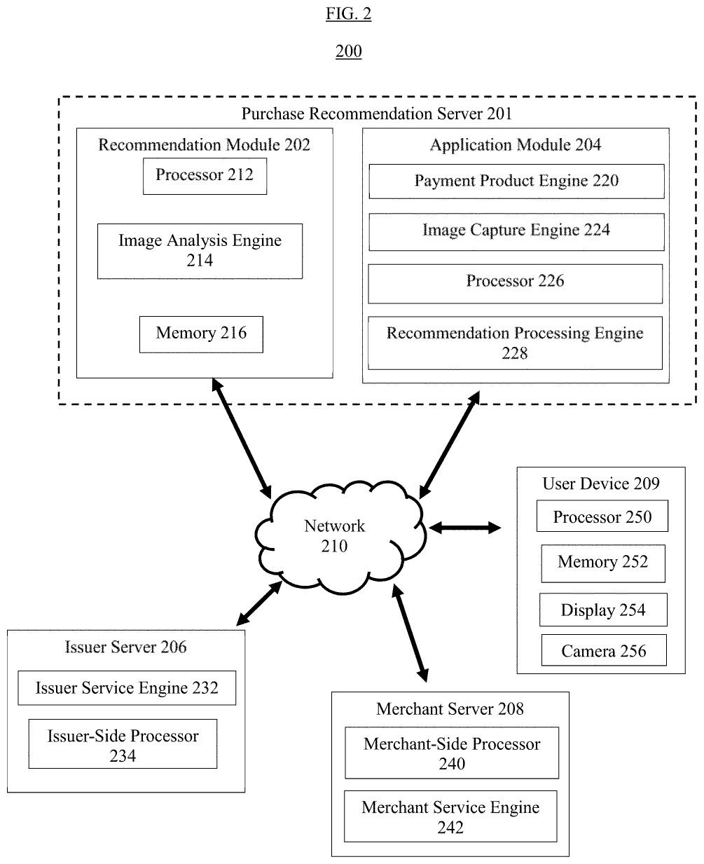

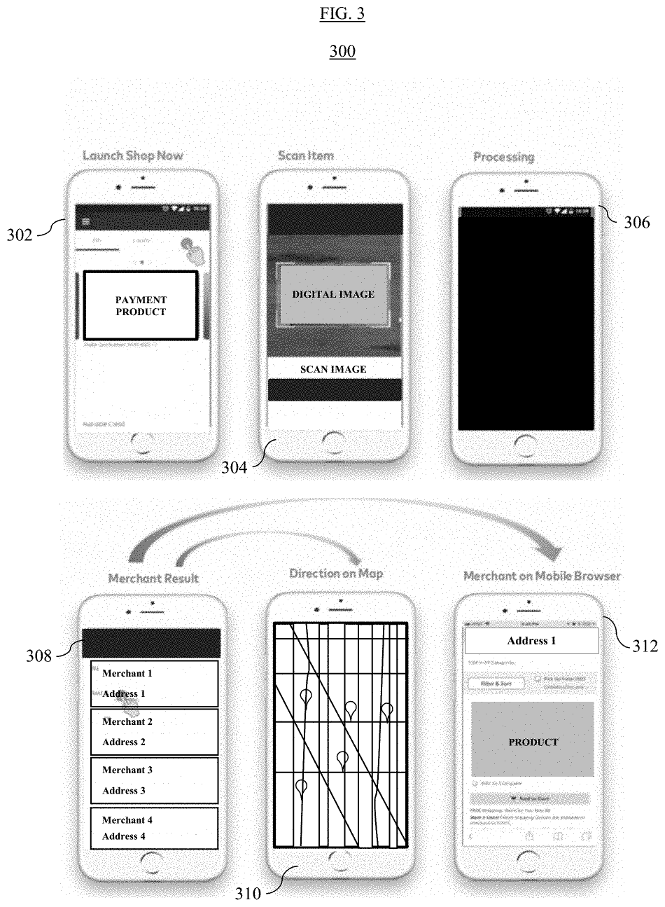

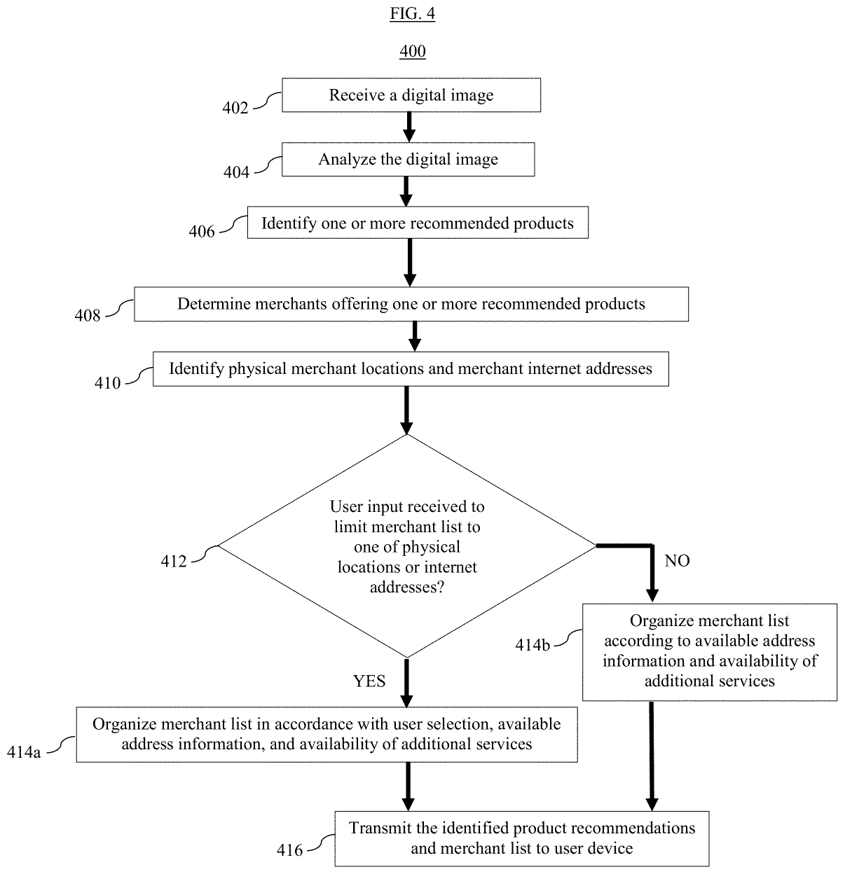

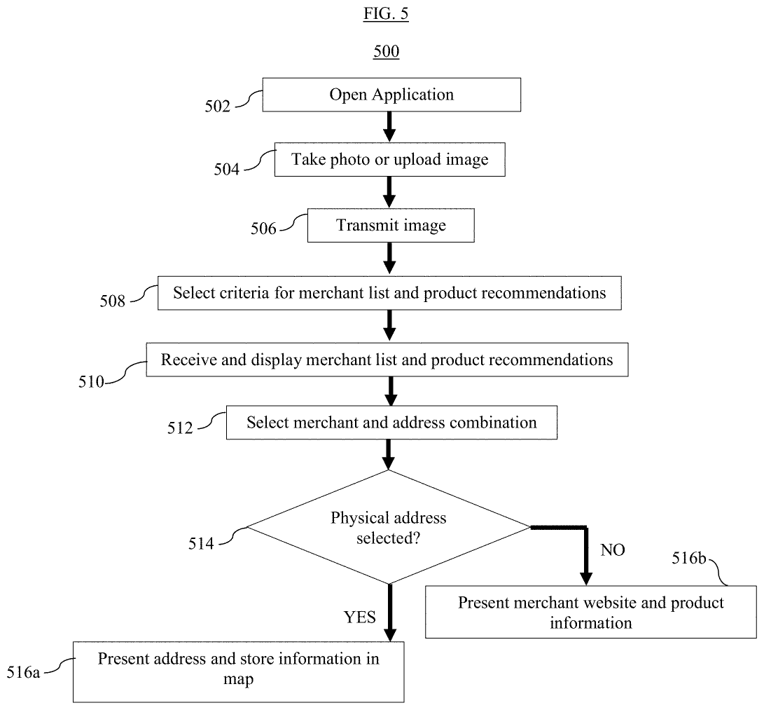

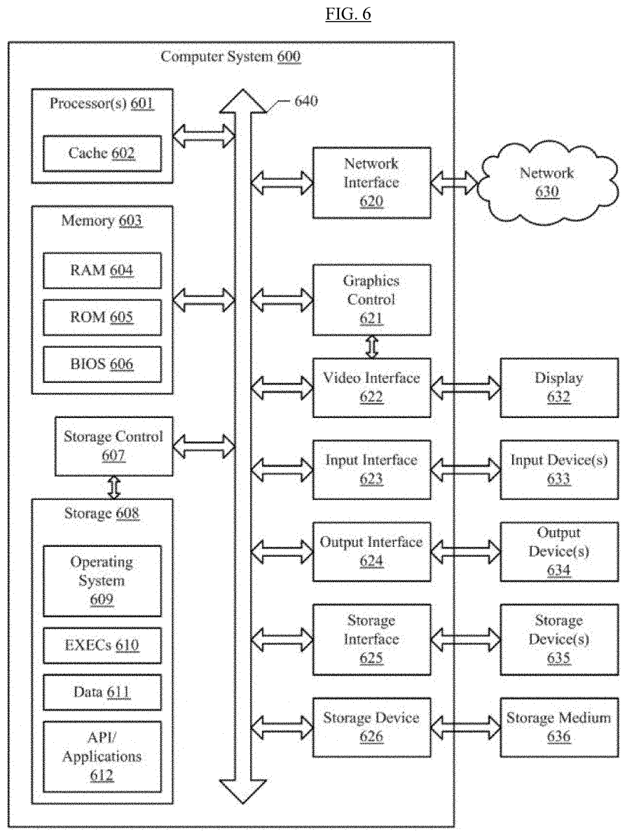

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, an exemplary embodiment of a payment networks for purchase recommendation in accordance with the disclosed subject matter is shown in FIG. 1. FIG. 2 is a diagram illustrating a system for purchase recommendation according to an illustrative embodiment of the disclosed subject matter. FIG. 3 is a diagram illustrating representative screenshots generated at a user device according to an illustrative embodiment of the disclosed subject matter. FIG. 4 is a flow chart illustrating a representative method for purchase recommendation, implemented according to an illustrative embodiment of the disclosed subject matter. FIG. 5 is a flow chart illustrating a representative method for purchase recommendation, implemented according to an illustrative embodiment of the disclosed subject matter, from the perspective of a user device. A block diagram illustrating further details of a representative computer system according to an illustrative embodiment of the disclosed subject matter is shown in FIG. 6.

While the present disclosed subject matter is described with respect to using methods and systems for forming and producing purchase recommendations, one skilled in the art will recognize that the disclosed subject matter is not limited to the illustrative embodiments. For example, the disclosed methods and system for purchase recommendation can be used with a wide variety of settings, such as in-store merchant transactions, promoting merchant and issuer services, and a variety of other applications.

FIG. 1 depicts a diagram illustrating a representative payment network 100 according to an illustrative embodiment of the disclosed subject matter. Payment network 100 can allow for payment transactions in which merchants and card issuers do not necessarily have a one-to-one relationship. The payment network 100, for example and without limitation a credit card payment system, can utilize an electronic payment network 140, such as the Mastercard® payment card system interchange network. Mastercard® payment card system interchange network is a proprietary communications standard promulgated by Mastercard International Incorporated® based on the ISO 8583 message format for the exchange of financial transaction data between financial institutions that are customers of Mastercard International Incorporated. (Mastercard is a registered trademark of MasterCard International Incorporated located in Purchase, N.Y.)

As embodied herein, the payment network 100 can include at least one merchant 110 connected to at least one electronic payment network 140, either directly or through an acquirer 120 via connection 115. At least one acquirer 120 can be connected to the electronic network 140, and each merchant 110 can be in communication with at least one acquirer 120 via the at least one payment network 140 or connection 115. At least one issuer 130 can be connected to the electronic network 140, and each acquirer 120 can be in communication with at least one issuer 130 via the electronic payment network 140.

For purpose of illustration and not limitation, in payment network 100, a financial institution, such as an issuer 130, can issue an account, such as a credit card account or a debit card account, to a cardholder (e.g., an individual consumer or a corporate or commercial customer), who can use the payment account card to tender payment for a purchase from a merchant 110 or to conduct a transaction at an ATM or website. To accept payment with the payment account card, merchant 110 can establish an account with a financial institution that is part of the financial payment system. This financial institution can be referred to as the “merchant bank” or the “acquiring bank,” or herein as “acquirer 120.” When a cardholder tenders payment for a purchase with a payment account card, the merchant, ATM, or website 110 can request authorization from acquirer 120 for the amount of the purchase. The request can be performed over the telephone, online via a web site, or through the use of a point-of-sale terminal which can read the cardholder's account information from the magnetic stripe on the payment account card, from a smart card using contact pads, or contactlessly from a near-field communication (NFC) device and communicate electronically with the transaction processing computers of acquirer 120. Alternatively, acquirer 120 can authorize a third party to perform transaction processing on its behalf. In this case, the point-of-sale terminal can be configured to communicate with the third party. Such a third party can be referred to as a “merchant processor” or an “acquiring processor.”

As embodied herein, using payment network 100, the computers of acquirer 120 or the merchant processor can communicate information regarding payment card transactions with computers of the issuer 130. For example and not limitation, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, the authorization request 125 can be declined or accepted, and an authorization response 135 can be transmitted from the issuer 130 to the acquirer 120, and then to the merchant, ATM, or website 110. The authorization request 125 can include account information identifying the merchant, location information (e.g., an address of the merchant), and transaction information, as discussed herein. The authorization response 135 can include, among other things, a result of the determination that the transaction is approved or declined and/or information about the status of the payment card or payment account.

For example and not limitation, at least one payment network server 150 can be connected to the electronic payment network 140 and configured to automatically capture the data representing a plurality of variables related to payment card transactions from the electronic payment network 140. Additionally, the payment network server can be connected to a system 200 for purchase recommendation either by the electronic payment network 140 or a separate connection 155. As embodied herein, the payment network server 150 can be configured to only capture the data representing a plurality of variables related to payment card transactions with the permission of the cardholder. Additionally, the payment network server 150 can be configured to only capture the information regarding payment card transactions in accordance with applicable data privacy laws.

FIG. 2 depicts a block diagram illustrating a representative system 200 for purchase recommendation according to an illustrative embodiment of the disclosed subject matter. The exemplary system 200 can include a recommendation module 202, an application module 204, an issuer server 206, merchant server 208, and user device 209, which can all communicate with each other over network 210. Network 210 may be a wireless network, local area network, the world wide web, or any other suitable network.

In some embodiments, the recommendation module 202 and application module 204 can both be included in a purchase recommendation server 201 and can share computing resources. For example, the processor 212 and processor 226 can be part of the same processor and/or can share processing circuitry and/or processing software. In some embodiments, the recommendation module 202 and application module 204 can be independent entities that do not share the same resources and can be located on different servers and/or in different locations.

In some embodiments, recommendation module 202 can include processor 212, image analysis engine 214, and memory 216. The image analysis engine 214 can be operable to receive a digital image from a user device 209, which can, in some embodiments, be sent via application module 204, which can provide additional processing before sending the digital image to the image analysis engine 214. In some embodiments, image analysis engine 214 can use image semantics analysis to analyze the received digital image, compare the digital image to images associated with known products, and produce a list of one or more recommended products based on the similarity of known products and the analyzed digital image. For example, such a comparison can compare the major features or characteristics of known products with those of the analyzed digital image and can thereby determine one or more products corresponding to the digital image. As embodied herein, recommendation module 202 can be configured to identify one or more merchants offering one or more recommended products. In some embodiments, recommendation module 202 can use a user location to identify merchants close to a user.

As embodied herein, the user device 209 can include a processor 250, a memory 252, a display 254, and a camera 256. The user device 209 can be a mobile computing device (e.g., smartphone, tablet, laptop, smartwatch, wearable computing device, etc.). A user of the user device 209 can capture an image with camera 256 to be uploaded through the application module 204. In addition, or alternatively, a stored image from memory 252 can be uploaded by a user using a user device 209.

In some embodiments, the user of user device 209 can send and receive data through a mobile application operated through application module 204. For example, a digital wallet application, which can enable the user device 209 to communicate with recommendation module 202, can be downloaded onto the user device 209 from an application store. Code stored in memory 252, in conjunction with processor 250 can open and execute the digital wallet application, which can serve as a means of storing and using various payment products.

In some embodiments, the captured image can be uploaded to the application module 204, for processing in conjunction with the recommendation module 202.

In some embodiments, application module 204 can include payment product engine 220, image capture engine 224, processor 226, and recommendation processing engine 228. In some embodiments, image capture engine 224 can send, receive, and/or process digital images received from user device 209. For example, in some embodiments, image capture engine can convert the digital image into a suitable format for processing by the recommendation module 202. In some embodiments, recommendation processing engine 228 can send, receive, and/or process product recommendations received from the recommendation module 202, for display on user device 209.

In some embodiments, issuer server 206 can include an issuer service engine 232 and an issuer-side processor 234, which can generate and provide information related to issuers, including payment products and additional services. For example, issuer service engine 232 can provide information related to identified services that may be recommended to a user in connection with one or more merchants. Such services can include, but are certainly not limited to rewards, loyalty benefits, airline miles, discounts at one or more merchants, exclusive and/or advanced offerings for payment products, events, and/or other financial products. For example, and not limitation, issuer server 206 can provide information related to a user's rewards points balance or balances, which can be provided to the recommendation module for presentation with a merchant list.

In some embodiments, merchant server 208 can include merchant-side processor 240 and merchant service engine 242, which can generate and provide information related to merchants, including the products offered by one or more merchants, as well as the additional services offered by one or more merchants. For example, merchant service engine 242 can provide information related to identified services that may be recommended to a user in response to the identification of an item of interest or one or more recommended products. Such services can include, but are certainly not limited to rewards, loyalty benefits, airline miles, discounts at one or more merchants, exclusive and/or advanced offerings for one or more products, and/or events, or membership opportunities associated with one or more merchants and/or one or more issuers.

FIG. 3 is a diagram illustrating screenshots generated at a user device according to an illustrative embodiment of the disclosed subject matter.

Screenshot 302 illustrates, by way of example and not limitation, an example of an application screen displayed on a display 254 of user device 209. In some embodiments, the application can be a digital wallet application.

Screenshot 304 illustrates, by way of example and not limitation, an example of an application screen which a user can use to capture an image of an item that is of interest to a user. For example, a user can capture an image of an item that the user encounters, using camera 256 of user device 209. For example, a user may decide to capture the image after seeing the item in a context in which further information about the product is not readily available, such as if the product is simply displayed by its owner. A user may therefore desire more information about the product, information about where and how to purchase the product, and information about the price of the product. In addition, a user may want more information about one or more additional services that may be offered by merchants who sell such products, or one or more additional services that may be offered by one or more issuers through which the user has access to payment products. Accordingly, a user can use a digital wallet application associated with one or more issuers to access some or all of this information by first capturing a digital image of the item, which can include one or more of a picture of the item itself, a picture of a part of the item, a QR code, a barcode on the item, a brand name, a product name, or a product logo. The digital image may be uploaded in various formats, such as in the form of a bitmap.

At screenshot 306, user device 209, utilizing processor 250 and code stored in memory 252, can carry out the process of capturing a digital image of the item of interest to the user, and can transmit the digital image to the recommendation module 202 for processing by the system. In some embodiments, the digital image may be transmitted to the recommendation module 202 by way of the application module 204, which can provide support, including carrying out one or more functions for the application being accessed by the user on user device 209.

Screenshot 308 illustrates, by way of example and not limitation, an example of a merchant list transmitted from the recommendation module 202 to the user device 209 and displayed on display 254. In this example, the merchant list is displayed as a list, with each merchant being associated with its corresponding address information. In some embodiments, the merchant list can be searchable, such as by text searching, or browsable, such as by scrolling. In some embodiments, the merchant list can be provided with one or more filtering options so that users can filter the results by one or more of product, merchant, services offered, or payment methods accepted. Address information can include one or more of a merchant's physical address or a merchant's internet address, such as the merchant's primary web site or another website that includes information related to recommended products or through which such products are offered for sale. A user can select a merchant and address combination for more information regarding the selected merchant, information related to the selected address and/or information related to the one or more recommended products offered by the selected merchant at the selected address.

The merchant list at screenshot 308 can be presented in an organized order based on additional services that are offered by one or more of the listed merchants or by one or more issuers associated with a payment product of a user. For example, an issuer associated with a payment product of a user can also be associated with the application being used by the user, and the merchant list can be organized based on whether the products offered by the listed merchants can be purchased with reward points associated with the issuer's payment product. Additionally or alternatively, the merchant list can be organized based on whether transactions with one or more merchants or for one or more of the products would be associated with a loyalty benefit of the merchant or through the issuer. For example, and certainly not by way of limitation, a merchant and address combination might be listed higher in the list if a transaction for the recommended product through that issuer would earn the user an increased number of reward points than if the user were to buy the product from another merchant. Additionally, or alternatively, a merchant and address combination might be listed higher in the list if the merchant offers discounts on the recommended product. Additionally or alternatively, an additional service associated with a merchant and address combination might be associated with one or more of the merchant, product, and issuer, in any combination. In some embodiments, the additional service can be time sensitive.

Screenshot 310 illustrates, by way of example and certainly not limitation, an example of a map display resulting from a user selecting a merchant associated with a physical address. In some embodiments, such a selection can cause screenshot 310 to show a map, including the location of a selected merchant. Additionally or alternatively, the map can display a variety of other information, including the locations of other similar merchants, other locations of the selected merchant, other locations offering the same or similar products as the recommended product, and/or the location of the user. For example, the location of the user can be determined using GPS information associated with user device 209 or can be based on one or more user inputs or settings. The map can be associated with a digital wallet application or can be launched through a separate maps application through user device 209.

Screenshot 312 illustrates, by way of example and certainly not limitation, an example of a merchant website, in the case of a user selecting a merchant and address combination including an internet address. For example, the merchant website can include information regarding one or more recommended products. Additionally, or alternatively, the merchant website can include one or more options for purchasing one or more recommended products.

FIG. 4 is a flow chart illustrating a representative method for purchase recommendation, implemented according to an illustrative embodiment of the disclosed subject matter.

As embodied herein, at 402, the recommendation module 202 can receive a captured image. The captured image can be received from the user device 209. Additionally or alternatively, the captured image can be received from the user device 209 by way of an application module 204. For example, and not limitation, a user can take a photo of an object with camera 256 of user device 209, and the photo can be uploaded, via application module 204, so that it is received by the recommendation module 202 as a digital image.

At 404, the recommendation module 202 can analyze the digital image using image semantics analysis to identify the image in reference to known products. For example, recommendation module 202 can compare the digital image, and/or data representing the digital image, to products with similar attributes that are offered by merchants. Such merchant-side product data can be accessed from memory 216, or from merchant server 208 via network 210. Additionally, or alternatively, data related to products offered by merchants can be stored in merchant server 208, along with information related to one or more merchants, including additional services offered by the one or more merchants.

In some embodiments, data related to product images that can be utilized for image semantic analysis can be stored in one or more of the recommendation module 202, merchant server 208, or issuer server 206. For example, a set of product data images can be stored and maintained for use in image semantics analysis. In some embodiments, the set of product data images can include images of products, which can be categorized by product type, image similarity, and major, and minor characteristics, to facilitate comparison with digital images using image semantics analysis. In some embodiments, recommendation module 202 can utilize one or more machine learning methods to analyze and identify digital images as corresponding to one or more products.

At 406, the recommendation module 202 can identify one or more recommended products. For example, the recommendation module 202 can analyze the digital image and identify a set of items that are related to the identified product corresponding to the digital image. For example, the digital image may be analyzed and found to be a specific digital watch, which recommendation module 202 can interpret as being related to digital watches, smart watches, or other electronic wristwear, such as one or more fitness trackers. In some embodiments, this determination can be made based on merchant data, product category codes, and/or issuer data related to product categories. In some embodiments, the digital image captured by the user and received by the system may be analyzed and compared to images of other products to determine a corresponding recommended product. In some embodiments, recommendation module 202 can identify the exact product and exclude only similar products from further results. In some embodiments, recommendation module 202 can be configured to identify a range of products having different levels of similarity with the analyzed digital image, and can provide product recommendations for products within certain categories of products related to the product of the digital image.

At 408, the recommendation module 202 can determine merchants that offer one or more of the recommended products. In some embodiments, merchants selling one or more of the products, at various prices, and with various additional related services may be identified. Recommendation module 202 can group the determined merchants by the type of products being offered. For example, if the digital image is identified as corresponding to one or more products, such as one or more different types of electronics, the determined merchants can be categorized by the recommendation module according to which merchants offer which specific electronics products. For example, and certainly not by way of limitation, recommendation module 202 can determine a set of merchants offering a certain smart watch that corresponds to an item of interest associated with the analyzed digital image and recommendation module 202 can also determine a set of merchants offering a certain fitness tracker wristband that corresponds to an item of interest associated with the analyzed digital image.

At 410, the recommendation module 202 can identify the addresses of the determined merchants. For merchants that have a physical address, the recommendation module 202 can identify the street address of the merchant. Additionally or alternatively, the recommendation module 202 can identify the location of the merchant on a map. For merchants that offer products for sale on the internet, the recommendation module 202 can identify the web site, internet address, and/or URL where the products can be reviewed and/or purchased.

At 412, the recommendation module can determine if user input has been received that indicates whether a merchant list to be generated should be limited to merchants with physical or internet addresses. For example, a user may be prompted, via the application module 204, to provide input indicating that the user would like a resulting merchant list to include merchants having only one or the other of a physical address or an internet address.

At 414a, the recommendation module 202 can organize a merchant list of the determined merchants and the corresponding identified products, in accordance with the user input to limit the resulting merchant list to merchants and one of a corresponding physical address or an internet address, and based on the availability of additional services associated with the merchants and identified products. For example, and not by way of limitation, additional services can include discounts, rewards, loyalty benefits or other additional services offered by the determined merchants. Additionally, or alternatively, the additional services can include discounts, rewards, loyalty benefits or other additional services offered by one or more issuers. For example, such additional services offered by one or more issuers can be generated by issuer service engine 232 in conjunction with issuer-side processor 234 for selection by recommendation module 202. In some embodiments, users can be provided with a merchant list along with a displayed rewards points balance of associated with an issuer or payment product of the user.

Additionally, or alternatively, at 414a, if user input is received to organize the merchant list by physical address only, the merchant list can be displayed in the form of a map that indicates the location of each merchant within a specified area. For example, the map may display all merchants offering one or more identified products within a certain distance from a location associated with a user device. Additionally, or alternatively, the map may be displayed in a maps application residing in the memory of user device 209 and launched in response to the user device 209 receiving the identified product recommendations and merchant list.

At 414b, the recommendation module 202 can perform the same organization function as in 414a, in conjunction with the merchant server 208 and issuer server 206, but at 414b, the merchant list can include the list of merchants and products offered, without regard for whether the resulting list contains merchants' physical or internet addresses. For example, the merchant list produced can include merchants having one or both of a physical address or an internet address, and the list can include both addresses.

At 416, the merchant list and corresponding product recommendations can be transmitted to user device 209. Additionally, or alternatively, the merchant list and product recommendations can be transmitted to user device 209 by way of application module 204. User device 209 can display the merchant list, including the one or more addresses for each merchant, and the product recommendations, on display 254.

FIG. 5 is a flow chart illustrating a representative method 500, for purchase recommendation implemented according to an illustrative embodiment of the disclosed subject matter, from the perspective of a user device.

As embodied herein, at 502, the user can launch an application from memory 252 on user device 209. For example, and certainly not by way of limitation, the application may be stored fully in memory 252 of user device 209, may be partially stored in memory 252, with partial storage in application module 204, or the application may be fully stored in application module 204, with information regarding the application being transmitted to user device 209. For example, and not by way of limitation, the application can be a digital wallet application. The application may contain information regarding one or more payment products of a user and one or more services available to a user, including one or more loyalty benefits, rewards, or discounts offered by one or more merchants and/or one or more issuers.

At 504, the user can take a photo or upload an image for analysis. For example, a user can take a photo using camera 256 of user device 209. Additionally, or alternatively, a user can access an image stored in memory 252. Additionally or alternatively, a digital image stored in memory 252 can be stored in one or more other applications that can be accessed by a user.

At 506, the user device 209 can transmit the image to recommendation module 202. In some embodiments, user device 209 can transmit the image to recommendation module 202 via application module 204, which may reside on the purchase recommendation server 201 with the recommendation module 202. At 506, recommendation module 202 can receive the digital image, corresponding to step 402, and can initiate the method discussed above with reference to FIG. 4.

At 508, the user can be prompted to select criteria for merchant list and product recommendations. For example, the user can provide a selection indicating which category or type of products should be included in the product recommendations. Additionally or alternatively, the user can provide input indicating whether a merchant list should include merchants having one, both, or either of a physical street address or an internet address.

At 510, the user device 209 can receive the merchant list and product recommendations and can present the merchant list and product recommendations using display 254.

At 512, the user can select a merchant and a merchant address from the display 254 of user device 209.

At 514, the processor 250 of user device 209 can determine if the user selected a merchant and address combination that corresponds to a physical address of a merchant.

At 516a, the user device 209 can present, using display 254, merchant and address information in map format, if a user selected a merchant and address combination corresponding to a merchant's physical address. For example, and certainly not by way of limitation, user device 209 can display merchant and address information within a map application. Additionally or alternatively, user device 209 can display merchant and address information on a map in relation to one or more of the locations of other merchants in the merchant list that was displayed to the user. Additionally or alternatively, user device 209 can display merchant and address information on a map in relation to the location of the user. For example, user device 209 can be operable to receive input related to the content and format of the map, including, but certainly not limited to the geographical range encompassed on the displayed map and the information displayed on the map related to the user and the selected merchant.

For example, the map can be interactive and can allow a user to select one or more merchants, one or more products, and/or one or more other map features. Additionally, or alternatively, the map can allow navigation to other applications, including applications related to merchant, product, and/or issuer content. For example, and certainly not by way of limitation, a user can select a merchant icon on a map to receive more information regarding the merchant, including but certainly not limited to one or more of the merchant's telephone number or other contact information, products offered by the merchant, or one or more services offered by the merchant, such as loyalty benefits, discounts, or rewards. Additionally or alternatively, the map can be configured to display information related to issuers, including but certainly not limited to one or more of the issuer's contact information, payment products offered by the issuer, or one or more services offered by the issuer, such as loyalty benefits, discounts, or rewards.

At 516b, the user device 209 can present, using display 254, the merchant's website and product information. For example, and certainly not by way of limitation, the processor 250 can execute instructions to navigate to a merchant website, to a section of a merchant website displaying products of a selected category, and/or to a section of a merchant website displaying one or more selected products.

FIG. 6 is a block diagram illustrating further details of a representative computer system according to an illustrative embodiment of the disclosed subject matter.

The systems and techniques discussed herein can be implemented in a computer system. As an example and not by limitation, as shown in FIG. 6, the computer system having architecture 600 can provide functionality as a result of processor(s) 601 executing software embodied in one or more tangible, non-transitory computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface 620. The software can cause processor(s) 601 to execute particular processes or particular parts of particular processes described herein, including defining data structures stored in memory 603 and modifying such data structures according to the processes defined by the software. An exemplary input device 633 can be, for example, a keyboard, a pointing device (e.g., a mouse), a touchscreen display, a microphone and voice control interface, a pressure sensor or the like to capture user input coupled to the input interface 623 to provide data and/or user input to the processor 601. An exemplary output device 634 can be, for example, a display (e.g., a monitor) or speakers or a haptic device coupled to the output interface 624 to allow the processor 601 to present a user interface, visual content, and/or audio content. Additionally or alternatively, the computer system 600 can provide an indication to the user by sending text or graphical data to a display 632 coupled to a video interface 622. Furthermore, any of the above components can provide data to or receive data from the processor 601 via a computer network 630 coupled the communication interface 620 of the computer system 600. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 601 includes hardware for executing instructions, such as those making up a computer program. As an example and not by way of limitation, to execute instructions, processor 601 can retrieve (or fetch) the instructions from an internal register, an internal cache 602, memory 603, or storage 608; decode and execute them; and then write one or more results to an internal register, an internal cache 602, memory 603, or storage 608. In particular embodiments, processor 601 can include one or more internal caches 602 for data, instructions, or addresses. This disclosure contemplates processor 601 including any suitable number of any suitable internal caches, where appropriate. As an example and not by way of limitation, processor 601 can include one or more instruction caches 602, one or more data caches 602, and one or more translation lookaside buffers (TLBs). Instructions in the instruction caches 602 can be copies of instructions in memory 603 or storage 608, and the instruction caches 602 can speed up retrieval of those instructions by processor 601. Data in the data caches 602 can be copies of data in memory 603 or storage 608 for instructions executing at processor 601 to operate on; the results of previous instructions executed at processor 601 for access by subsequent instructions executing at processor 601 or for writing to memory 603 or storage 608; or other suitable data. The data caches 602 can speed up read or write operations by processor 601. The TLBs can speed up virtual-address translation for processor 601. In some embodiments, processor 601 can include one or more internal registers for data, instructions, or addresses. This disclosure contemplates processor 601 including any suitable number of any suitable internal registers, where appropriate. Where appropriate, processor 601 can include one or more arithmetic logic units (ALUs); be a multi-core processor; or include one or more processors 601. Although this disclosure describes and illustrates a particular processor, this disclosure contemplates any suitable processor.

In some embodiments, memory 603 includes main memory for storing instructions for processor 601 to execute or data for processor 601 to operate on. As an example and not by way of limitation, computer system 600 can load instructions from storage 608 or another source (such as, for example, another computer system 600) to memory 603. Processor 601 can then load the instructions from memory 603 to an internal register or internal cache 602. To execute the instructions, processor 601 can retrieve the instructions from the internal register or internal cache 602 and decode them. During or after execution of the instructions, processor 601 can write one or more results (which can be intermediate or final results) to the internal register or internal cache 602. Processor 601 can then write one or more of those results to memory 603. In some embodiments, processor 601 executes only instructions in one or more internal registers or internal caches 602 or in memory 603 (as opposed to storage 608 or elsewhere) and operates only on data in one or more internal registers or internal caches or in memory 603 (as opposed to storage 608 or elsewhere). One or more memory buses (which can each include an address bus and a data bus) can couple processor 601 to memory 603. Bus 640 can include one or more memory buses, as described below. In particular embodiments, one or more memory management units (MMUs) reside between processor 601 and memory 603 and facilitate accesses to memory 603 requested by processor 601. In some embodiments, memory 603 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 603 can include one or more memories 604, where appropriate. Although this disclosure describes and illustrates particular memory, this disclosure contemplates any suitable memory.

In some embodiments, storage 608 includes mass storage for data or instructions. As an example and not by way of limitation, storage 608 can include a hard disk drive (HDD), a floppy disk drive, flash memory, an optical disc, a magneto-optical disc, magnetic tape, or a Universal Serial Bus (USB) drive or a combination of two or more of these. Storage 608 can include removable or non-removable (or fixed) media, where appropriate. Storage 608 can be internal or external to computer system 600, where appropriate. In some embodiments, storage 608 is non-volatile, solid-state memory. In some embodiments, storage 608 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. Storage 608 can include one or more storage control units facilitating communication between processor 601 and storage 608, where appropriate. Where appropriate, storage 608 can include one or more storages 608. Although this disclosure describes and illustrates particular storage, this disclosure contemplates any suitable storage.

In some embodiments, input interface 623 and output interface 624 can include hardware, software, or both, providing one or more interfaces for communication between computer system 600 and one or more input device(s) 633 and/or output device(s) 634. Computer system 600 can include one or more of these input device(s) 633 and/or output device(s) 634, where appropriate. One or more of these input device(s) 633 and/or output device(s) 634 can enable communication between a person and computer system 600. As an example and not by way of limitation, an input device 633 and/or output device 634 can include a keyboard, keypad, microphone, monitor, mouse, printer, scanner, speaker, still camera, stylus, tablet, touch screen, trackball, video camera, another suitable input device 633 and/or output device 634 or a combination of two or more of these. An input device 633 and/or output device 634 can include one or more sensors. This disclosure contemplates any suitable input device(s) 633 and/or output device(s) 634 and any suitable input interface 623 and output interface 624 for them. Where appropriate, input interface 623 and output interface 624 can include one or more device or software drivers enabling processor 601 to drive one or more of these input device(s) 633 and/or output device(s) 634. Input interface 623 and output interface 624 can include one or more input interfaces 623 or output interfaces 624, where appropriate. Although this disclosure describes and illustrates a particular input interface 623 and output interface 624, this disclosure contemplates any suitable input interface 623 and output interface 624.

As embodied herein, communication interface 620 can include hardware, software, or both providing one or more interfaces for communication (such as, for example, packet-based communication) between computer system 600 and one or more other computer systems 600 or one or more networks. As an example and not by way of limitation, communication interface 620 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 620 for it. As an example and not by way of limitation, computer system 600 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 600 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 can include any suitable communication interface 620 for any of these networks, where appropriate. Communication interface 620 can include one or more communication interfaces 620, where appropriate. Although this disclosure describes and illustrates a particular communication interface, this disclosure contemplates any suitable communication interface.

In some embodiments, bus 640 includes hardware, software, or both coupling components of computer system 600 to each other. As an example and not by way of limitation, bus 640 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 640 can include one or more buses 604, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A computer-implemented method for image-based purchase recommendation, comprising:
receiving, by processing circuitry, a digital image corresponding to an item of interest;
analyzing the digital image, by the processing circuitry, thereby identifying one or more corresponding recommended products;
determining, by the processing circuitry, one or more merchants that offer one or more of the recommended products;
identifying, by the processing circuitry, a location of each merchant that has a physical location, and an internet address of each merchant that offers the one or more recommended products for sale on the internet;
organizing the one or more merchants, by the processing circuitry, based on an availability of additional services offered by the one or more merchants or by one or more issuers, to form a list of recommended merchants; and
transmitting to a user device, by the processing circuitry, the identified one or more recommended products, the list of merchants, and the identified merchant location or internet address for each merchant as a displayed list, wherein the displayed list includes one or more filtering options configured to filter the results based on one or more of product, merchant, services offered, or payment methods accepted.

2. The computer-implemented method of claim 1, wherein the digital image includes one of a captured image of a product, a bitmap, a QR code, a barcode, a brand name, a product name, or a product logo.

3. The computer-implemented method of claim 1, wherein the additional services include one or more offers associated with a merchant or rewards associated with a payment product.

4. The computer-implemented method of claim 1, wherein the list of merchants transmitted to a user device includes the additional services offered by the one or more merchants or one or more issuers.

5. The computer-implemented method of claim 1, wherein organizing the one or more merchants, by the processing circuitry, further comprises:
organizing the list of merchants based on one or more user inputs indicating whether the list of merchants should include one or both of physical merchant locations and internet addresses for each merchant.

6. The computer-implemented method of claim 1, wherein the identified one or more products, the list of merchants, and the identified merchant location or internet address for each merchant are configured to be displayed in coordination with an application associated with one or more payment products.

7. The computer-implemented method of claim 6, wherein the application is configured to display the identified one or more products, the list of merchants, and the identified merchant location or internet address for each merchant.

8. The computer-implemented method of claim 1, wherein organizing the one or more merchants further comprises:
organizing the one or more merchants, by the processing circuitry, based on whether the one or more merchants accept a particular payment product or payment via a particular payment method.

9. The computer-implemented method of claim 6, wherein the digital image is transmitted to the processing circuitry via the application.

10. The computer-implemented method of claim 1, further comprising:
transmitting, by the processing circuitry, the identified one or more products, the list of merchants, and the identified merchant location or internet address for each merchant, configured as a one of a searchable list or a map of merchant locations.

11. A system for image-based purchase recommendation, comprising:
at least one memory storing computer program code; and
at least one processor;
wherein the computer program code is configured, when executed by the at least one processor, to cause the system to:
receive a digital image corresponding to an item of interest;
analyze the digital image and thereby identify one or more corresponding recommended products;
determine one or more merchants that offer one or more of the recommended products;
identify a location of each merchant that has a physical location, and an internet address of each merchant that offers the one or more recommended products for sale on the internet;
organize the one or more merchants based on an availability of additional services offered by the one or more merchants or by one or more issuers, to form a list of recommended merchants; and
transmit, to a user device, the identified one or more recommended products, the list of merchants, and the identified merchant location or internet address for each merchant as a displayed list, wherein the displayed list includes one or more filtering options configured to filter the results based on one or more of product, merchant, services offered, or payment methods accepted.

12. The system of claim 11, wherein the digital image includes one of a captured image of a product, a bitmap, a QR code, a barcode, a brand name, a product name, or a product logo.

13. The system of claim 11, wherein the additional services include one or more offers associated with a merchant or rewards associated with a payment product.

14. The system of claim 11, wherein the list of merchants transmitted to a user device includes the additional services offered by the one or more merchants or one or more issuers.

15. The system of claim 11, further configured to:
organize the list of merchants based on one or more user inputs indicating whether the list of merchants should include one or both of physical merchant locations and internet addresses for each merchant.

16. The system of claim 11, wherein the identified one or more products, the list of merchants, and the identified merchant location or internet address for each merchant are configured to be displayed in coordination with an application associated with one or more payment products.

17. The system of claim 16, wherein the application is configured to display the identified one or more products, the list of merchants, and the identified merchant location or internet address for each merchant.

18. The system of claim 11, further configured to:
organize the one or more merchants based on whether the one or more merchants accept a particular payment product or payment via a particular payment method.

19. The system of claim 16, wherein the digital image is transmitted to the processing circuitry via the application.

20. The system of claim 11, further configured to:
transmit the identified one or more products, the list of merchants, and the identified merchant location or internet address for each merchant, configured as a one of a searchable list or a map of merchant locations.
